(19) United States
(12) Patent Application Publication
(10) Pub. No.: US 2026/0252041 A1
(43) Pub. Date: Aug. 27, 2026

(54) MULTIMODAL QUESTION AND ANSWER FOR MODEL TRAINING

(71) Applicant: TOYOTA RESEARCH INSTITUTE, INC., Los Altos, CA (US)

(72) Inventors: Guy ROSMAN, Cambridge, MA (US); Jonathan A. DECASTRO, Arlington, MA (US); Emily S. SUMNER, Cambridge, MA (US); Deepak EDAKKATTIL GOPINATH, Washington, DC (US); Andrew M. SILVA, Cambridge, MA (US); Thomas M. BALCH, Damariscotta, ME (US); Xiongyi CUI, Somerville, MA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 19/060,343

(22) Filed: Feb. 21, 2025

(51) Int. Cl. G05B 13/02; B60W 50/00; B60W 60/00

(52) U.S. Cl. CPC G05B 13/0265; B60W 50/00; B60W 60/00; B60W 2050/0028

(57) ABSTRACT

A method for generating training data for machine learning models includes generating a driving scenario, displaying the driving scenario to a group of annotators through one or more interfaces, and providing a feedback interface to collect multimodal feedback from one or more annotators of the group of annotators. The method also includes receiving multimodal feedback from a second annotator of the group of annotators in response to one or more prompts by at least a first annotator of the group of annotators. The one or more prompts corresponding to the driving scenario. The method further includes receiving, from a third annotator, a first evaluation score of the first multimodal feedback. The method also includes integrating the multimodal feedback into a training dataset for training the machine learning model in accordance with the first evaluation score being greater than a score threshold.

### FIELD

Aspects of the present disclosure generally relate to artificial neural networks, and more specifically to gathering training data for model training via multimodal questions and answers.

### BACKGROUND

Machine learning models are trained on training data. The ability to develop high-quality machine learning models, particularly foundational models, is based on the availability of high-quality, diverse training data. Training data serves as the basis for teaching models how to perform tasks such as object detection, language understanding, and decision-making. In various field, such as autonomous driving, healthcare, and natural language processing, creating training datasets that are both representative and diverse is critical for ensuring robust model performance across a wide range of real-world scenarios.

In the context of autonomous systems, in most cases, machine learning models are trained via supervised or unsupervised learning. Supervised learning relies on labeled data, where human annotators or automated systems provide explicit labels for each data point. This method, while effective, can be time-intensive and expensive, particularly for complex applications, such as autonomous driving, where nuanced and multimodal data may be required. Unsupervised learning, on the other hand, uses unlabeled data and leverages patterns within the data to train models. While cost-effective, unsupervised learning is often insufficient for capturing context-specific nuances or edge cases critical for decision-making in high-stakes environments.

### SUMMARY

In some aspects of the present disclosure, a method for generating training data for machine learning models includes generating a driving scenario based on one or more historical driving scenarios, the driving scenario including contextual environmental details. The method further includes displaying the driving scenario to a group of annotators via one or more interfaces. The method also includes providing, to the group of annotators, a feedback interface to solicit multimodal feedback from one or more annotators of the group of annotators. The method further includes receiving, from a second annotator of the group of annotators in response to one or more prompts by at least a first annotator of the group of annotators, first multimodal feedback, the first multimodal feedback including two or more of a visual annotation to the driving scenario, a textual response, a verbal response, or physical feedback via a driving simulation device. The method also includes receiving, from a third annotator, a first evaluation score of the first multimodal feedback. The method further includes integrating the first multimodal feedback into a training dataset for training the machine learning model in accordance with the first evaluation score being greater than a score threshold.

Some other aspects of the present disclosure are directed to an apparatus. The apparatus includes means for generating a driving scenario based on one or more historical driving scenarios, the driving scenario including contextual environmental details. The apparatus further includes means for displaying the driving scenario to a group of annotators via one or more interfaces. The apparatus also includes means for providing, to the group of annotators, a feedback interface to solicit multimodal feedback from one or more annotators of the group of annotators. The apparatus further includes means for receiving, from a second annotator of the group of annotators in response to one or more prompts by at least a first annotator of the group of annotators, first multimodal feedback, the first multimodal feedback including two or more of a visual annotation to the driving scenario, a textual response, a verbal response, or physical feedback via a driving simulation device. The apparatus also includes means for receiving, from a third annotator, a first evaluation score of the first multimodal feedback. The apparatus further includes means for integrating the first multimodal feedback into a training dataset for training the machine learning model in accordance with the first evaluation score being greater than a score threshold.

In some other aspects of the present disclosure, a non-transitory computer-readable medium with program code recorded thereon is disclosed. The program code is executed by one or more processors and includes program code to generate a driving scenario based on one or more historical driving scenarios, the driving scenario including contextual environmental details. The program code further includes program code to display the driving scenario to a group of annotators via one or more interfaces. The program code also includes program code to provide, to the group of annotators, a feedback interface to solicit multimodal feedback from one or more annotators of the group of annotators. The program code further includes program code to receive, from a second annotator of the group of annotators in response to one or more prompts by at least a first annotator of the group of annotators, first multimodal feedback, the first multimodal feedback including two or more of a visual annotation to the driving scenario, a textual response, a verbal response, or physical feedback via a driving simulation device. The program code also includes program code to receive, from a third annotator, a first evaluation score of the first multimodal feedback. The program code further includes program code to integrate the first multimodal feedback into a training dataset for training the machine learning model in accordance with the first evaluation score being greater than a score threshold.

Some other aspects of the present disclosure are directed to an apparatus for generating training data for machine learning models. The apparatus includes one or more processors and one or more memories coupled with the one or more processors and storing processor-executable code that, when executed by the one or more processors, is configured to cause the apparatus to generate a driving scenario based on one or more historical driving scenarios, the driving scenario including contextual environmental details. Execution of the processor-executable code further causes the apparatus to display the driving scenario to a group of annotators via one or more interfaces. Execution of the processor-executable code also causes the apparatus to provide, to the group of annotators, a feedback interface to solicit multimodal feedback from one or more annotators of the group of annotators. Execution of the processor-executable code further causes the apparatus to receive, from a second annotator of the group of annotators in response to one or more prompts by at least a first annotator of the group of annotators, first multimodal feedback, the first multimodal feedback including two or more of a visual annotation to the driving scenario, a textual response, a verbal response, or physical feedback via a driving simulation device. Execution of the processor-executable code also causes the apparatus to receive, from a third annotator, a first evaluation score of the first multimodal feedback. Execution of the processor-executable code further causes the apparatus to integrate the first multimodal feedback into a training dataset for training the machine learning model in accordance with the first evaluation score being greater than a score threshold.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example of a system for detecting weld spatter, in accordance with aspects of the present disclosure.

FIG. 2 is a diagram illustrating an example of a hardware implementation for a system for detecting weld spatter, in accordance with aspects of the present disclosure.

FIG. 3 is a block diagram illustrating an example of a training data system, in accordance with various aspects of the present disclosure,

FIG. 4A is a diagram illustrating an example of a scenario generated by a training data system, in accordance with various aspects of the present disclosure.

FIG. 4B is a diagram illustrating an example of feedback provided to a virtual scenario, in accordance with various aspects of the present disclosure.

FIG. 5 is a diagram illustrating an example of a simulator that may be used to depict a driving scenario, in accordance with various aspects of the present disclosure.

FIG. 6 is a block diagram illustrating an example for training a model, in accordance with various aspects of the present disclosure.

FIG. 7 is a flow diagram illustrating an example process for gathering training data, in accordance with various aspects of the present disclosure.

### DETAILED DESCRIPTION

The detailed description set forth below and in Appendix A, in connection with the appended drawings, is intended as a description of various configurations and is not intended to represent the only configurations in which the concepts described herein may be practiced. The detailed description include specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and the drawings are merely illustrative of the present disclosure rather than limiting, the scope of the present disclosure being defined by the appended claims and equivalents thereof.

As discussed, machine learning models are trained on training data. The ability to develop high-quality machine learning models, such as foundational models, is based on the availability of high-quality, diverse training data. For ease of explanation, machine learning models may also be referred to as models, hereinafter used interchangeably. Training data serves as the basis for teaching models how to perform various tasks, such as, but not limited to, object detection, language understanding, and decision-making. Creating training datasets that are both representative and diverse improves model performance across a wide range of real-world scenarios in various fields, such as autonomous driving, healthcare, and natural language processing.

Recent advancements in training have introduced active learning techniques, which prioritize the collection of data points that are most informative for model training. These active learning techniques focus on reducing the volume of training data while maintaining or improving model accuracy. However, these techniques often fail to generate richly annotated datasets for complex, interactive environments, such as those encountered by autonomous vehicles or semi-autonomous vehicles in dynamic decision-making scenarios. This limitation underscores the need for innovative approaches to training data generation that include contextual depth. As machine learning models are increasingly expected to handle tasks requiring reasoning and explanation, the quality of the training data must extend beyond simple annotations. That is, it may be desirable for training data to include context-rich, scenario-specific annotations that capture human-like decision-making and reasoning processes.

Various aspects of the present disclosure are directed to generating training data to improve the reasoning, planning, and decision-making capabilities of machine learning models. In some examples, the machine learning model may be a foundational model used in, for example, complex, interactive environments such as shared autonomy driving scenarios or fully autonomous driving scenarios. Shared autonomous refers to a scenario where a vehicle is jointly operated by a human operator and an autonomous system. In some examples, a gamified, annotator-driven approach may be used to obtain contextual annotations that are otherwise difficult to obtain through conventional training systems.

In some examples, a group of annotators may interact with a training system to generate training data. The training system may be based on one or more of a synthetic driving scenario, a semi-synthetic driving scenario, or a real-world driving scenario. These scenarios may include visual elements, such as a top-down view of a road environment, depicting vehicles, and other contextual details. Additionally, or alternatively, the scenario may require one or more annotators to control an actual vehicle or a virtual vehicle. In some such examples, a moderator or a first annotator may initiate the process by forming a question about the scenario, which may include both visual and language-based inputs, and providing instructions to the other annotators. A second annotator may respond to the question, which may involve providing inputs and feedback, such as marking a location, providing a trajectory, or answering in textual form. A third annotator may evaluate the response from the second annotator, offering introspection, ranking, and reasoning about the answer's validity, completeness, or alignment with the scenario.

In some examples, a gamified framework may be specified to incentivize the annotators, encouraging them to explore a wide range of scenario aspects and provide nuanced, context-rich annotations. In some examples, tasks may be dynamically scheduled for the annotators, such that the annotators are guided to generate diverse and meaningful interactions. As a result, the training system covers edge cases and scenarios critical for training models. This approach not only diversifies the dataset but also provides annotations that emphasize reasoning and counterfactual thinking, enabling models to better predict, plan, and act in complex, real-world situations.

Additionally, the training system integrates multimodal inputs, including visual annotations, textual responses, and even vehicle controls, such as simulated steering inputs, to provide comprehensive data for foundational models. These diverse inputs enable the models to learn across modalities, bridging the gap between visual understanding, language processing, and motor planning. By combining human-like decision-making and reasoning with scenario-specific annotations, the system produces datasets that are suited for training models capable of both autonomous decision-making and explaining their actions.

This innovative data generation system addresses existing limitations in training data collection by introducing a robust framework for eliciting diverse and complex annotations. The resulting training data enables machine learning models to reason more effectively about dynamic scenarios, improving their ability to perform in environments where traditional data collection methods fall short.

Particular aspects of the subject matter described in this disclosure can be implemented to realize one or more of the following potential advantages. In some examples, the described techniques for generating and/or gathering training data through an annotator framework may improve an ability of a machine learning model (e.g., foundational model) to reason about complex, dynamic scenarios. This improved reasoning includes the ability to interpret and respond to nuanced, context-specific inputs, such as those encountered in shared autonomy and autonomous driving applications. Additionally, the diverse and multimodal nature of the training data—encompassing visual, textual, and behavioral annotations—enhances the model's capacity to generalize across different modalities and scenarios. The system's incorporation of counterfactual reasoning and context-specific annotations further enables the foundational model to perform better in decision-making and planning benchmarks, ultimately leading to safer and more effective autonomous systems.

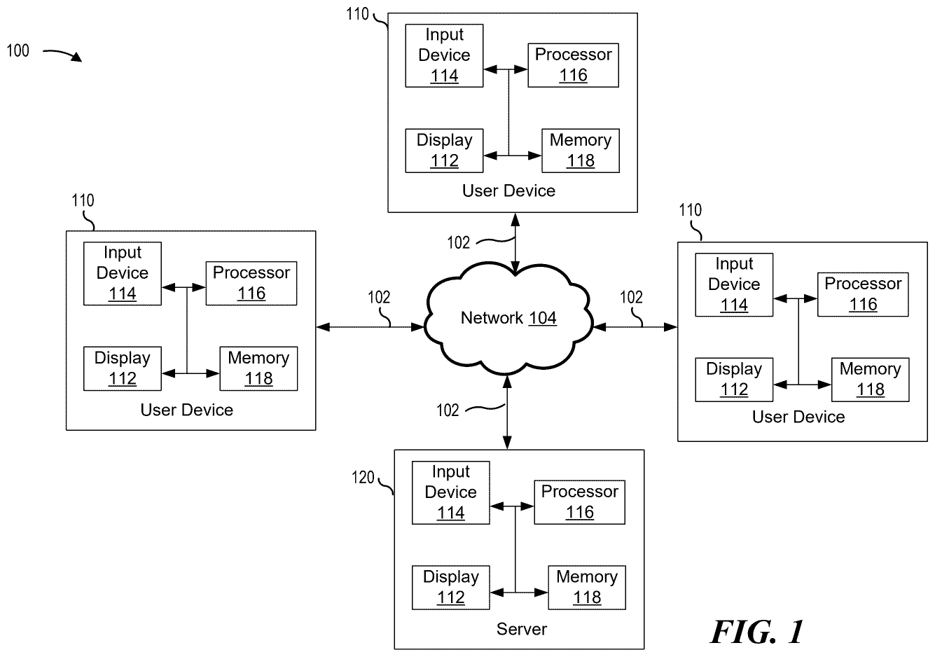

FIG. 1 is a block diagram illustrating an example of a system 100 for gathering training data via a question and answer session with a group of annotators, in accordance with aspects of the present disclosure. As shown in the example of FIG. 1, the system 100 may include one or more user devices 110 and one or more servers 120. The user devices 110 may be examples of a personal computer (PC), a user equipment, a mobile device, a driver simulation device, and/or any other computing device. For ease of explanation, only one server 120 is shown in the example of FIG. 1. Each user device 110 may be connected to a network 104 via one or more communication links 102. The communication links 102 may be wired and/or wireless communication links. The server 120 may also be connected to the network 104 via a communication link 102.

The network 104 may be an example of the Internet. Additionally, or alternatively, the network 104 may include any suitable computer network such as an intranet, a wide-area network (WAN), a local-area network (LAN), a wireless network, a digital subscriber line (DSL) network, a frame relay network, an asynchronous transfer mode (ATM) network, and/or a virtual private network (VPN). The communication links 102 may be any type of communication link that may be suitable for communicating data between user devices 110 and the server 120. For example, the communication links 102 may include one or more of network links, dial-up links, wireless links (e.g., Wi-Fi link, satellite link, or cellular communication link), and/or hard-wired links.

The server 120 may be a computing device, such as a server, processor, computer, cloud computing device, cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to host a training data model, a question and answer model, and/or other types of machine learning models, and communicate via a wireless or wired medium. In some examples, the server 120 may host the weld spatter model, the spot weld model, and/or other types of machine learning models. In some such examples, one or more server 120 may work in tandem to host the weld spatter model, the sport weld model, and/or other types of machine learning models. Specifically, the server 120 may implement functions and/or computer code that runs training data model, a question and answer model, and/or other types of machine learning models.

As noted, each user device 110 may be an example a device that is configured to communicate via a wireless or wired medium. In some examples, each user device 110 shown in FIG. 1 may be used by a different user. Each user device 110 and server 120 may be stationary or mobile.

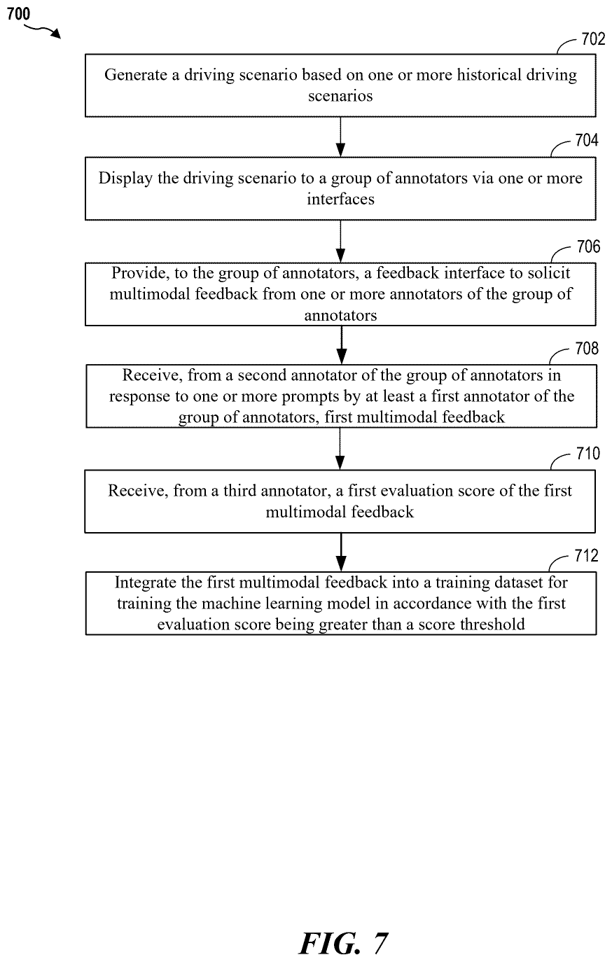

In some examples, each user device 110 may be included inside a housing that houses components of the user device 110, such as one or more processors 116 and a memory 118. The housing may also include, or be connected to, a display 112 and an input device 114, which may be interconnected with other components of the user device 110. For ease of explanation, only one processor 116 is shown for each user device 110. In some examples, the one or more processors 116, the display 112, the input device 114, and the memory 118 may be interconnected via a bus architecture. The memory 118 may include one or more different types of memory, such as random access memory (RAM), static RAM (SRAM), dynamic RAM (DRAM), and/or another type of memory. Each user device 110 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the user device 110. The input device 114 may be used to navigate the interface associated with the surrogate model, and/or perform other tasks. Working in conjunction with one or more components of the user device 110, the processor 116 may receive information associated with the training data model, the question and answer model, and/or other types of machine learning models, and control the display 112 to output information associated with the one or more models. The display 112 may output (e.g., display) information received at the processor 116. In some examples, the processor 116 of the user device 110 is configured to perform operations and implement one or more elements associated with one or more processes, such as the process 700 described with respect to FIG. 7.

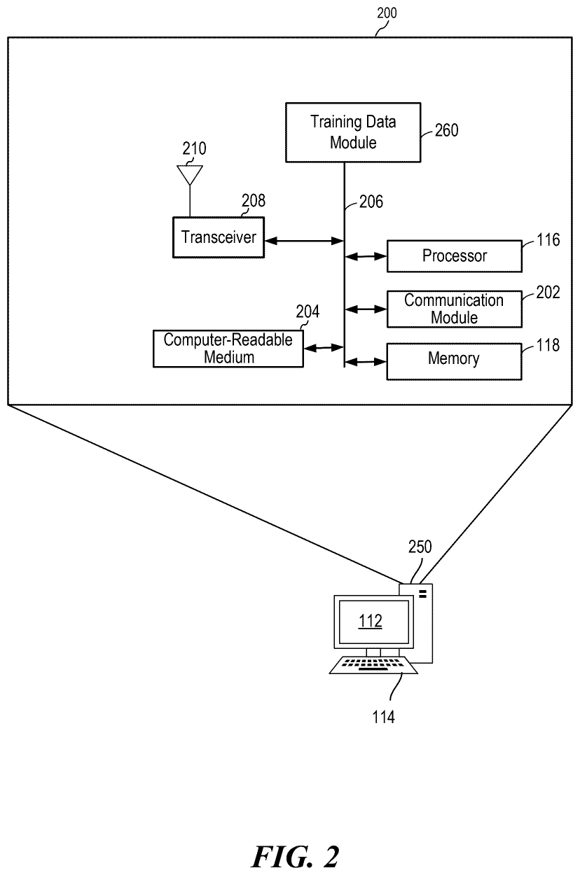

In some examples, a server 120 may be included inside a housing that houses components of the server 120, such as one or more processors 116 and a memory 118. The housing may also include, or be connected to, a display 112 and an input device 114, which may be interconnected with other components of the user device 110. For ease of explanation, only one processor 116 is shown for the server 120. In some examples, the one or more processors 116, the display 112, the input device 114, and the memory 118 may be interconnected via a bus architecture. The memory 118 may include one or more different types of memory, such as RAM, SRAM, DRAM, and/or another type of memory. The server 120 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the server 120. For example, the processor 120 may execute instructions for maintaining training data model, a question and answer model, and/or other types of machine learning models, training the training data model, the question and answer model, and/or other types of machine learning models, and/or executing training data model, the question and answer model, and/or other types of machine learning models. In some examples, the processor 116 of the server 120 is configured to perform operations and implement one or more elements associated with one or more processes, such as the process 700 described with respect to FIG. 7. Additionally, or alternatively, the processor 116 of the server 120 may be configured to perform operations associated with the training data module 260 described with reference to FIG. 2.

FIG. 2 is a diagram illustrating an example of a hardware implementation for a system 200, according to various aspects of the present disclosure. The system 200 may be a component of a device 250. The device 250 may be an example of a user device 110 or a server 120 described with reference to FIG. 1. As shown in the example of FIG. 2, the device 250 may include a display 112 and an input device 114 (e.g., a keyboard). In some examples, the system 200 is configured to perform operations and implement one or more elements associated with one or more processes, such as the process 700 described with respect to FIG. 7.

The system 200 may be implemented with a bus architecture, represented generally by a bus 206. The bus 206 may include any number of interconnecting buses and bridges depending on the specific application of the system 200 and the overall design constraints. The bus 206 links together various circuits including one or more processors and/or hardware modules, represented by a processor 116, and a communication module 202. The bus 206 may also link various other circuits such as timing sources, peripherals, voltage regulators, and power management circuits, which are well known in the art, and therefore, will not be described any further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. For example, the transceiver 208 may receive commands via transmissions from a user or a remote device.

As shown in the example of FIG. 2, the system 200 may include a training data module 260 that may be trained to facilitate a multimodal question and answer session for gather training data. For example, the training data module 260 may be trained to perform the tasks described with reference to the one or more modules, machine learning models, and/or engines. The training data module 260 may include artificial or computational intelligence elements, such as, neural network, fuzzy logic, or other machine learning algorithms. The training data module 260 may include the training data model, the question and answer model, and/or any other type of machine learning model. In one or more arrangements, one or more of the other modules 116, 118, 202, 204, 208, can also include artificial or computational intelligence elements, such as, neural network, fuzzy logic, or other machine learning algorithms. Further, in one or more arrangements, one or more of the modules 116, 118, 202, 204, 208 can be distributed among multiple modules 116, 118, 202, 204, 208, 260 described herein. In one or more arrangements, two or more of the modules 116, 118, 202, 204, 208, 260 of the system 200 can be combined into a single module.

The system 200 includes the processor 116 coupled to the computer-readable medium 204. The processor 116 performs processing, including the execution of software stored on the computer-readable medium 204 providing functionality according to the disclosure. The software, when executed by the processor 116, causes the system 200 to perform the various functions described for a particular device, such as any of the modules 116, 118, 202, 204, 208, 260. For example, when executed by the processor 116, the software causes the system 200 and/or the training data module 260 to implement one or more elements associated with one or more processes, such as the process 700 described with respect to FIG. 7. The computer-readable medium 204 may also be used for storing data that is manipulated by the processor 116 when executing the software. For example, working in conjunction with one or more of the other modules the modules 116, 118, 202, 204, and 208, the training data module 260 may perform one or more operations, such as the operations of the process 700 described with reference to FIG. 7.

In some examples, the system 200 may include one or more of the modules 116, 118, 202, 204, 208, and 260 described with reference to FIG. 2. For example, the system 200 may include one or more processors 116 and one or more memories 118.

As indicated above, FIGS. 1 and 2 are provided as examples. Other examples may differ from what is described with regard to FIGS. 1 and 2.

As discussed, various aspects of the present disclosure are directed to generating training data designed to improve the reasoning, planning, and decision-making abilities of machine learning models, such as, for example, foundational models. These models, commonly used in complex and interactive environments, benefit from the diverse and richly annotated datasets produced by this system. In some examples, a model may be used for shared autonomy, where a vehicle is jointly controlled by a human operator and an autonomous system. Additionally, or alternatively, the model may be used in fully autonomous driving contexts. To overcome the limitations of traditional data collection methods, various aspects of the present disclosure may use a gamified, annotator-driven approach to obtain contextual and nuanced annotations that are challenging to achieve otherwise.

In some examples, multiple annotators may interact with the training system to generate high-quality data based on one or more of a synthetic driving scenario, a semi-synthetic driving scenario, or a real-world driving scenario. These scenarios may include visually detailed environments, such as a top-down view of roads with vehicles, pedestrians, and other contextual elements. In some embodiments, annotators may interact with physical or virtual vehicles to simulate driving behaviors. A moderator or first annotator initiates the annotation process by posing a scenario-related question, which combines visual and language-based inputs and guides subsequent annotators. The second annotator provides detailed responses, such as marking locations, suggesting trajectories, or offering textual feedback. A third annotator evaluates the second annotator's contributions, ranking responses, providing introspection, and reasoning about their alignment with the scenario's context.

In some examples, a gamified structure incentivizes annotators to engage deeply with the system, encouraging exploration of a wide range of scenario aspects. The gamified structure may provide various rewards, such as monetary rewards and/or other rewards. Dynamic scheduling may direct annotators toward critical tasks, ensuring diverse and meaningful interactions. This approach facilitates coverage of edge cases and complex scenarios that may allow for robust model training.

In some examples, a training system integrates multimodal data inputs, including visual annotations, textual feedback, and even simulated vehicle controls such as steering actions. These inputs allow models to learn across multiple modalities, bridging visual comprehension, language processing, and motor planning. By integrating human-like reasoning with contextual scenario annotations, the system produces datasets optimized for training models to make autonomous decisions and explain their reasoning.

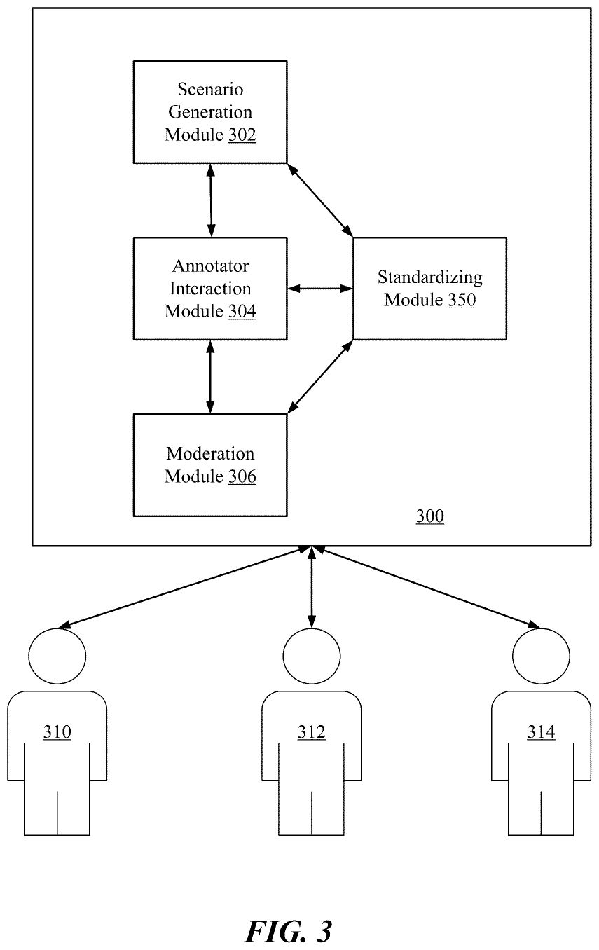

FIG. 3 is a block diagram illustrating an example of a training data system 300, in accordance with various aspects of the present disclosure. As shown in the example of FIG. 3, the training data system 300 integrates several components 302, 304, and 306 to achieve its goals, including a scenario generation module 302, an annotator interaction module 304, and a moderation module 306. These components work 302, 304, and 306 together to produce richly annotated data tailored for machine learning models.

In some examples, the scenario generation module 302 generates one or more driving scenario. Each driving scenario may be a synthetic driving scenario, a semi-synthetic driving scenario, or a real-world driving scenario. These scenarios present complex conditions, such as intersections with unclear markings, merging vehicles with conflicting priorities, or pedestrians entering crosswalks unexpectedly. For instance, a scenario might show a vehicle attempting a left turn while another vehicle accelerates into the same lane. Scenarios include visual elements such as top-down views of roads, vehicles, pedestrians, and environmental objects. The system also allows annotators to modify scenarios or add contextual elements, ensuring coverage of edge cases.

Synthetic driving scenarios are examples of entirely computer-generated driving scenarios and do not incorporate real-world data. These driving scenarios may be created using virtual environments and simulated data, often generated by learned models or predefined rules. In some examples, the synthetic driving scenario may be based on real-world data captured by one or more vehicles. These synthetic driving scenarios may include purely virtual elements, such as vehicles, pedestrians, road layouts, weather conditions, and traffic signals. The synthetic driving scenarios are controlled environment, which allow for testing specific edge cases or rare events, such as a pedestrian suddenly crossing the road or a vehicle running a red light. Additionally, synthetic scenarios are scalable, enabling the generation of thousands of scenarios quickly for extensive testing and training. Since these scenarios are virtual, they also eliminate any risk to real-world vehicles or pedestrians during testing.

Semi-synthetic driving scenarios combine real-world data with virtual elements, blending the realism of real-world conditions with the flexibility of synthetic data. Real-world data is captured using sensors, such as cameras, LiDAR, or radar, on vehicles or other data sources. Virtual elements, such as a virtual pedestrian or vehicle, may be integrated into the real-world data to create hybrid scenarios. This approach retains the complexity and unpredictability of real-world driving while allowing for the addition of specific situations that may not have been captured in the real-world data. For example, a real-world dataset of a highway driving scenario could be augmented with a virtual vehicle that suddenly changes lanes without signaling, testing the user's ability to handle aggressive driving behaviors. Semi-synthetic scenarios are also cost-effective, as they reduce the need to capture every possible real-world scenario, saving time and resources.

Real-world driving scenarios are based entirely on data captured from actual driving conditions. This data is collected from vehicles equipped with sensors, user studies, or other real-world sources. Real-world scenarios provide the most accurate representation of actual driving conditions, including the unpredictability of human behavior and environmental factors. For example, a real-world scenario may show a vehicle navigating through a busy city intersection during rush hour, with data captured from the vehicle's sensors showing the positions and movements of other vehicles, pedestrians, and traffic signals. In the case of the real-world driving scenario, the scenario generation module 302 does not generate the scenario, rather, the scenario generation module 302 may output the real-world data. For example, the scenario generation module 302 may output an image or video corresponding to data captured by a forward-facing camera of a vehicle.

The annotator interaction module 304 facilitates structured collaboration among a group of annotators 310, 312, and 314. For example, the annotator interaction module 304 dynamically schedules these tasks based on the complexity of the scenario and the annotators'expertise, ensuring balanced workloads and comprehensive analysis. The annotator interaction module 304 may work in conjunction with one or both of the scenario generation module 302 or the moderation module 306.

The example of FIG. 3 uses three annotators 310, 312, and 314, additional or fewer annotators may be used. The annotators 310, 312, and 314 may be remotely located from each other or in a same environment, such as in a same testing room. Each annotator 310, 312, and 314 may interact with the training data system 300. For example, a first annotator 310 creates a question about the scenario, such as, “What is the safest path for the ego vehicle?” A second annotator 312 responds with an answer, such as marking a trajectory on the map or providing a textual explanation. A third annotator 314 evaluates a response of the second annotator 312, offering a ranking or detailed reasoning, such as, “The marked path avoids collisions but may cause delays due to abrupt stops.” The module supports multimodal inputs, including textual descriptions, visual annotations, and behavioral inputs, such as simulated steering. Each annotator 310, 312, and 314 may be a human.

The moderation module 306 may be a virtual moderator that dynamically assigns tasks and guides annotators 310, 312, and 314 to explore diverse aspects of scenarios. The term dynamic, in the context of the moderation module 306, refers to the ability of the moderation module 306 to actively adapt and respond to the evolving state of the annotation process, providing a structured yet flexible approach to generating comprehensive and diverse training data. Unlike static systems with predefined workflows, the moderation module 306 may assess the current state of annotation tasks, scenario complexity, and annotator responses in real-time to assign tasks and guide interactions effectively.

The moderation module 306 may facilitate a thorough exploration of each scenario by taking an active role in managing annotators'tasks. For example, the moderation module 306 may prompt the first annotator 310 to pose counterfactual questions, such as, “What if the pedestrian had stopped walking midway?” Such prompts introduce hypothetical variations, encouraging exploration of alternative outcomes that might not naturally arise during standard annotations. The moderation module 306 may direct the second annotator 312 to provide detailed visual annotations, such as marking trajectories or highlighting key points of interest, focusing on areas requiring clarification, or adding depth to the dataset.

For the third annotator 314, the moderation module 306 may assign introspection and evaluation tasks, guiding them to assess the accuracy and completeness of the second annotator's input and justify their evaluation with reasoning. For example, the third annotator might be asked, “Does the marked trajectory align with the intended goal, and why or why not?” This process ensures the collected data is both diverse and contextually validated, enhancing the quality of the training dataset.

In some embodiments, the moderation module 306 is powered by a trained machine learning model, such as a large language model (LLM), capable of analyzing annotations and scenario data in real-time. This model identifies gaps or areas requiring additional exploration and generates prompts or tasks to address these deficiencies. By continuously adapting to the progress and outcomes of the annotation process, the moderation module 306 maximizes the diversity and quality of the training data, ensuring comprehensive coverage of critical scenarios. Alternatively, the moderation module 306 may be operated by a human moderator, such as one of the annotators (e.g., annotator 310) or a dedicated facilitator, to guide interactions.

The moderation module 306 also orchestrates more complex, multimodal interactions. For instance, in a multimodal conversation, the moderation module 306 may challenge annotators to explore scenarios in greater depth by introducing prompts, such as “Drive as though you are fatigued; predict how your behavior might increase the risk of an accident.” In this example, the moderation module 306 could schedule an annotator to simulate driving behavior using a steering wheel interface, incorporating a behavioral layer into the data collection process. Subsequently, another annotator might evaluate the simulated behavior and provide insights or corrections.

Beyond task assignment, the moderation module 306 fosters iterative improvements by creating a feedback loop. Annotators 310, 312, and 314 are encouraged to respond to follow-up questions, justify their decisions, or address additional counterfactual scenarios, such as, “What if the vehicle behind you suddenly accelerated?” This iterative approach ensures that annotators explore a wide range of possibilities and produce nuanced, multimodal data, including textual explanations, visual annotations, and behavioral inputs. Through this dynamic and interactive process, the moderation module 306 facilitates the generation of high-quality training data critical for developing robust machine learning models.

The training data system 300 is designed to generate high-quality, multimodal training data through the interaction of the annotators 310, 312, and 314 and a dynamic moderation module 306. Specifically, the training data system 300 has the ability to actively guide annotators 310, 312, and 314 to provide deeper and more meaningful responses. For example, if the first annotator 310 is tasked with writing a follow-up question, the system can prompt them to ask for more depth, such as requesting detailed reasoning or exploring specific facets of the scenario. For the next annotator 312, the system might instruct them to compose a response or additional question that covers a new perspective or introduces complexity, thereby enriching the dialog.

The system 300 may also challenge annotators 310, 312, and 314 to explore alternative or more difficult scenarios. For instance, the system 300 may present the model's current result and prompt the second annotator 312 with, “This is the model's interpretation. Can you propose a counterexample or a scenario that challenges this result?” The annotator could then generate a follow-up questions, such as “What if the vehicle suddenly encounters an obstacle in the alternate lane?” This ensures that the dialog includes scenarios that test the model's limitations, broadening the scope of annotations and exposing edge cases. By providing instructions to annotators 310, 312, and 314 based on the model's needs, the system 300 may guide an annotator 310, 312, or 314 to explore alternative outcomes, ask “what if” questions, or delve into scenarios that human intuition might identify but a machine might not.

In some examples, one or more modules 302, 304, or 306 of the training data system 300 may be trained using advanced machine learning techniques to improve the training data system's ability to guide discussions, assign tasks, and elicit diverse and high-quality annotations. In one embodiment, one or more modules may be implemented as a trained large language model (LLM), or multimodal LLM, that may be trained to generate scenarios, generate prompts, analyze responses, and/or encourage further exploration of scenarios. Each module 302, 304, and/or 306 may be trained separately or in one or more combinations. Each module 302, 304, and/or 306 may be an example of the training data model configured to gather training data and/or the question and answer model that is configured to facilitate the question and answer session. That is, one or both of the training data model and the question and answer model may perform the operations described in conjunction with the modules 302, 304, and/or 306.

In some examples, the training process involves multiple stages. Initially, the one or more modules 302, 304, or 306 may be exposed to a large corpus of annotated data, including examples of successful interactions, real-world and/or virtual scenarios, meaningful prompts, and comprehensive annotations. This training dataset may encompass a variety of driving scenarios, ranging from routine events, such as navigating through an intersection to complex, high-risk situations such as avoiding pedestrians or responding to emergency vehicles. The dataset can also include multimodal inputs, such as visual annotations and textual descriptions, to teach the moderator how to handle different types of data.

During training, some modules, such as the annotator interaction module 304 or the moderation module 304 may learn to identify patterns in annotator behavior and scenario complexity. For example, the LLM may be trained to recognize when an annotator has provided a superficial response, such as marking a trajectory without explaining the rationale. In such cases, the moderation module 304 may generate follow-up prompts, such as “Why did you select this trajectory, and how does it account for the police vehicle's sudden acceleration?” This ensures that annotations are contextually rich and complete.

The moderation module 304 may also be trained to dynamically adapt its prompts based on the scenario. For instance, if a scenario involves a vehicle approaching an intersection with ambiguous lane markings, the moderator could pose a question such as, “What should the ego vehicle do if the lane markings disappear completely?” Alternatively, the moderator could suggest counterfactuals to deepen the analysis, such as, “What if the opposing vehicle suddenly moves into the ego vehicle's lane?”

To enhance its capabilities, the training of the one or more modules 302, 304, or 306 may incorporate reinforcement learning techniques. In this phase, the one or more modules 302, 304, or 306 are rewarded for generating prompts and scheduling tasks that result in diverse, high-quality annotations. For example, if prompts of the moderation module 304 lead annotators to explore a previously unconsidered edge case, the moderation module 304 receives positive reinforcement, refining its ability to generate effective prompts over time.

The LLM-based modules 302, 304, and/or 306 may also leverage pretraining on general language understanding and contextual reasoning tasks, enabling respective modules 302, 304, and 306 to handle a wide range of scenarios and annotator inputs. For example, one or more modules 302, 304, or 306 may evaluate responses in real time, identify areas where additional clarification is needed, and provide constructive feedback. For example, the moderation module 306 may analyze a textual response and suggest, “Your answer does not account for the speed of the pedestrian entering the crosswalk. Please revisit your annotation.”

To further enhance multimodal functionality, one or more modules 302, 304, or 306 may be integrated with visual analysis capabilities. For example, the moderation module 306 may analyze a visual annotation provided by an annotator, identify inconsistencies (e.g., a trajectory that conflicts with the vehicle's likely behavior), and prompt corrections. One or more modules 302, 304, or 306 may also evaluate behavioral inputs, such as steering data, by comparing the simulated driving behavior against the scenario's context to ensure consistency.

In some examples, the scenario generation module 302 may generate synthetic data to enrich the training dataset. For example, the scenario generation module 302 may create hypothetical scenarios based on patterns observed during interactions, such as, “Simulate a case where the ego vehicle is required to merge into heavy traffic with limited visibility.” These synthetic scenarios provide additional opportunities for annotators to explore complex and challenging situations.

Multimodal data, by its nature, originates from various sources and is often formatted inconsistently, making it challenging to integrate directly into a machine learning training system. This data may include textual responses, visual annotations, speech inputs, and behavioral signals from simulation devices, each captured in different formats, resolutions, or structures. For example, visual data such as annotated images or videos may come in various formats, such as PNG, JPEG, or MP4, with varying frame rates and labeling conventions. Textual responses may be stored in various formats, such as plain text, JSON, or XML, often without a consistent structure. Audio responses, such as spoken explanations from annotators, may be recorded in various formats, such as WAV or MP3, requiring transcription before processing. Simulation data, including steering, braking, and acceleration inputs, might be captured as time-series data or in raw numerical streams, often specific to the driving simulator being used. Without a standardized structure, these different data types cannot effectively align or be input into a machine learning model, leading to inconsistencies, inefficiencies, and potential biases.

To address this issue, training data system 300 may include a standardizing module 350 that receives and standardize multimodal data in a unified format compatible with the training pipeline. The standardizing module 350 may structure each type of multimodal input within a metadata framework, such as JSON, YAML, or a database table, such that all data sources are referenced together. For example, a structured format might link a visual annotation with a textual explanation, an audio file, and corresponding simulation data, ensuring that all inputs align and remain accessible. The standardizing module 350 may then normalize file formats and data representations. Additionally, or alternatively, the standardizing module 350 resizes images to a fixed resolution and stores them in a uniform format, such as PNG, while tokenizing and embedding text responses for easier processing by natural language models. Additionally, or alternatively, the standardizing module 350 may transcribe and normalizes verbal responses to ensure consistency, and resample simulation data to a fixed rate so that all behavioral inputs align with the corresponding visual and textual data.

After normalizing the raw data, the standardizing module 350 may synchronize the raw data to maintain temporal alignment between multimodal inputs. For example, in a driving scenario, the standardizing module 350 maps steering inputs from a simulator to the corresponding video frames and annotations, ensuring the model can associate behavioral actions with visual and contextual cues. Additionally, the standardizing module 350 may encode the data to prepare the data for model training. The standardizing module 350 may also embed textual inputs as vector representations, transforms audio responses into spectrograms for deep learning-based speech models, and structures behavioral data as numerical feature vectors representing real-world driving decisions.

Once standardized, the standardizing module 350 stores the data in a format optimized for machine learning training. In some examples, the standardizing module 350 organizes structured tabular data in CSV or Parquet files, while large multimodal datasets are formatted as TFRecord files for TensorFlow-based models or HDF5 files for efficient access and retrieval. By curating the training dataset with balanced representation across different driving scenarios, the standardizing module 350 ensures the machine learning model is exposed to a diverse and comprehensive dataset.

Consider an autonomous driving scenario where an ego vehicle approaches an intersection with a pedestrian crossing. The dataset might include a top-down image with an annotated trajectory, a textual response describing the expected vehicle behavior, a spoken explanation recorded as an audio file, and steering and braking data from a driving simulator. Through the standardization process, the standardizing module 350 resizes and stores the image annotation in a predefined format, tokenizes the text response for natural language processing, transcribes the audio file and maps it to the corresponding visual data, and resamples the driving inputs to a fixed frequency. Once structured in a unified dataset, these inputs train a machine learning model capable of understanding and predicting vehicle behavior across a wide range of real-world scenarios.

By implementing this structured approach, the standardizing module 350 captures, processes, and formats multimodal feedback from annotators—whether visual, textual, verbal, or behavioral—in a way that maximizes the effectiveness of machine learning training. Standardization eliminates inconsistencies and enhances the quality and diversity of training data, ultimately improving the model's ability to make accurate and reliable predictions in complex environments. As shown in the example of FIG. 3, the standardizing module 350 may interact with one or more modules 302, 304, or 306 to receive multimodal feedback provided by one or more annotators 310, 312, or 314.

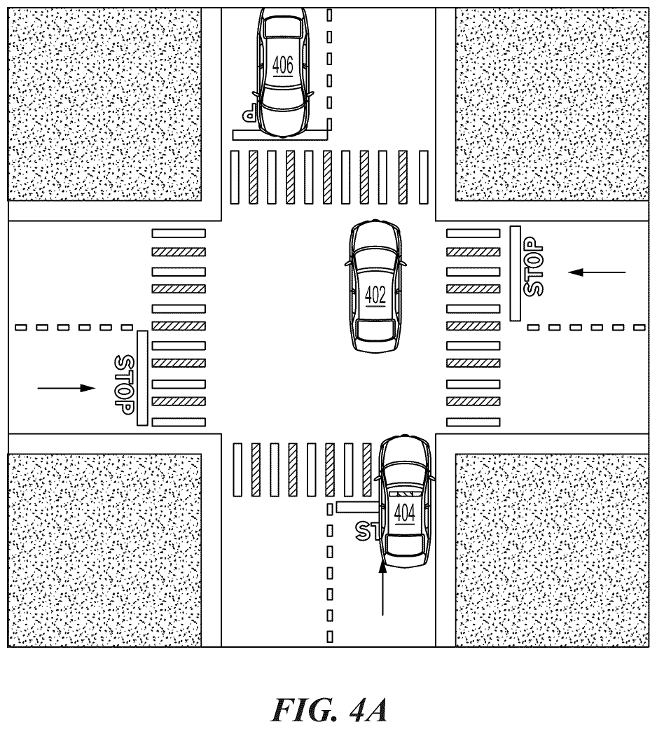

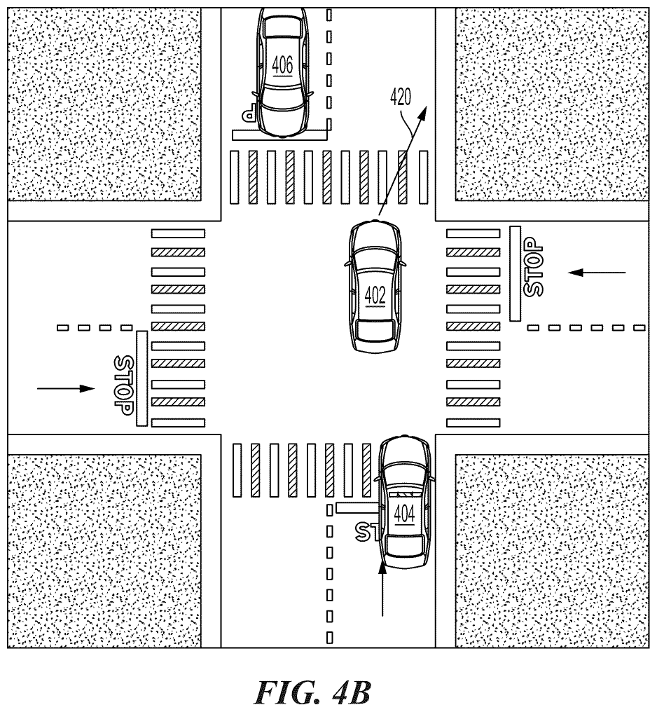

FIG. 4A is a diagram illustrating an example of a scenario generated by a training data system, in accordance with various aspects of the present disclosure. The training data system may be an example of the training data system 300 described with reference to FIG. 3. In the example of FIG. 4A, a scenario generation module, such as the scenario generation module 302 described with reference to FIG. 3, may generate a scenario 400 that depicts the historical behavior of vehicles 402, 404, and 406, including the ego vehicle 402 and other entities, such as a police vehicle 404 and another vehicle 406 in a given environment. This scenario may include visual data, such as a bird's-eye view of the road, and may also incorporate additional contextual information, such as lane markings, stop signs, crosswalks, and the relative positions of the vehicles. The scenario 400 may be based on video inputs, synthetic reconstructions, or a combination of both. The goal is to simulate complex interactions, allowing annotators to engage with the system in a structured, gamified manner.

The additional contextual information may be visually included in the scenario 400 and/or provided as background information via text and/or audio. The additional contextual information in the scenario 400 provides depth and specificity, making the data more realistic and informative for annotators and machine learning models. The additional contextual information may include, for example, traffic signals and patterns, such as the states of traffic lights (e.g., green, yellow, or red) and pedestrian crossing signals with their associated timings. The contextual information may also include dynamic behaviors of vehicles and pedestrians, including one or more factors, such as current speeds, trajectories, and sudden changes in movement, such as abrupt stops or lane changes. Additionally, or alternatively, the contextual information may also include environmental conditions, such as weather (rain, snow, fog), time of day (dawn, dusk, or night), and road surface conditions (wet, icy, or potholes), further enhance the realism of scenarios by introducing situational challenges.

Additionally, or alternatively, the contextual information may include infrastructure details, including, but not limited to lane markings (e.g., clear, faded, or absent), road signs (e.g., stop signs, speed limits), and the geometry of the road (e.g., curves, inclines, or intersections). Additionally, or alternatively, the contextual information may include social dynamics between drivers and pedestrians, such as yielding behaviors or gestures. Additionally, or alternatively, the contextual information may include metadata about the scenario, such as the purpose of the trip (e.g., school drop-off, delivery, or casual drive) and annotator objectives (e.g., prioritize safety, minimize travel time). Additionally, or alternatively, the contextual information may include auxiliary objects, such as bicycles, scooters, parked vehicles, or barriers. Additionally, or alternatively, the contextual information may include the temporal evolution of the scenario 400, encompassing the sequence of events leading to the current situation and the historical behaviors of the entities involved.

The scenario 400 is an example of an intersection where the ego vehicle 402, or the driver of the ego vehicle 402, must decide how to proceed while interacting with the other vehicles. The police vehicle 404 is positioned behind the ego vehicle 402, while the vehicle 406 approaches the intersection from another direction. This setup introduces potential complexities in decision-making, such as yielding to the police vehicle, considering whether the police vehicle has its siren or lights activated, or interpreting the behavior of the approaching vehicle 406.

A group of annotators may interact with the scenario 400 in a sequence of tasks moderated by a moderation module, such as the moderation module 306 described with reference to FIG. 3. For example, a first annotator may initiate the process by generating a question about the scenario. For example, the first annotator may ask, “Tell me how the ego vehicle 402 will react to the police car 404?” This question encourages the annotators to consider the possible behaviors of the ego vehicle, such as whether it will yield, proceed cautiously, or stop entirely. The first annotator may also ask variations of the first question or follow-up questions, such as, “Tell me how the ego vehicle 402 will react to the police car 404 if the siren and lights of the police car 404 are on?” These questions guide the exploration of the scenario and focus on uncovering contextual nuances that are critical for training robust models. Additionally, or alternatively, the first annotator may ask counterfactual questions, such as, “Tell me how the ego vehicle 402 will react if the police car 404 was driving on the sidewalk?”

A second annotator may respond to the question by providing an answer in textual form and/or as a visual annotation, such as marking a trajectory in the scenario 400. The annotator may highlight specific elements of the scenario 400, such as potential paths for the ego vehicle 402 or areas of interest, to add clarity and detail. FIG. 4B is a diagram illustrating an example of feedback provided to a virtual scenario, in accordance with various aspects of the present disclosure. Specifically, FIG. 4B is a diagram illustrating an example of a trajectory of the ego vehicle 402, provided by the second annotator, in response to the police vehicle 404 activating its siren and lights. As shown in the example of FIG. 4B, the second annotator draws a path 420 indicating that the ego vehicle may pull over to a side of the road. Additionally, or alternatively, the second annotator may provide a textual response, such as “the ego vehicle will pull over to the side of the road.”

A third annotator may evaluate the second annotator's response, offering introspection and reasoning about the validity and alignment of the response with the scenario's context. For example, the third annotator may comment, “The ego vehicle's 402 marked trajectory is appropriate if the police car 404 has its sirens on, but if the siren is not activated, the ego vehicle 402 should not yield and stop at the side of the road.” This evaluation provides critical validation and ensures the annotations are nuanced and contextually accurate. The third annotator can also compare multiple responses and provide a ranked evaluation, fostering richer and more nuanced annotations.

Each annotator may be rewarded for their participation. By incorporating dynamic moderation, the training system improves the diversity and depth of the annotations, such that the training data reflects realistic and complex interactions. The result is a training dataset that equips foundational models to handle nuanced driving scenarios, enabling safer and more effective autonomous decision-making.

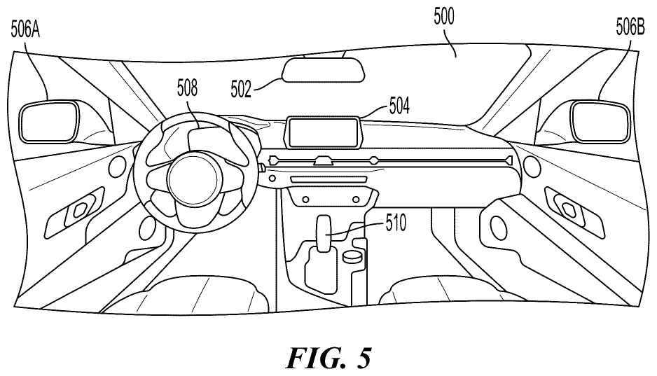

The scenario 400 depicted in FIGS. 4A and 4B, while primarily shown as a bird's-eye view (e.g., top-down view), is not limited to this perspective. Other views and configurations are contemplated to provide diverse contextual information and enable richer interactions for the annotators. For instance, the training system may incorporate a simulator environment that mimics the experience of operating a real vehicle. FIG. 5 is a diagram illustrating an example of a simulator 500 that may be used to depict a driving scenario, in accordance with various aspects of the present disclosure. The driving scenario may be synthetic, semi-synthetic, or based on real-world data. However, regardless of its origin, the driving scenario is presented to the user (e.g., annotator) within a virtual environment. In such an example, one or more annotators could be seated in the simulator 500, interacting with the scenario as though they were inside the ego vehicle or another vehicle in the scene. This simulator environment may include physical components such as a steering wheel 508, accelerator (not shown in the example of FIG. 5), brake pedals (not shown in the example of FIG. 5), gear shifter 510, and dashboard controls 504, providing a tactile and immersive experience. The simulator's visual display may replicate the view from a vehicle's front windshield, offering a realistic depiction of the road, traffic, and surrounding environment. The display may also include side mirrors 506A and 506B and a rearview mirror 502 to present a complete field of vision, enabling the annotator to consider blind spots, overtaking vehicles, or approaching pedestrians.

The simulated environment may dynamically adapt to the scenario being analyzed. For example, if the scenario involves a busy intersection with complex interactions between vehicles and pedestrians, the simulator may render real-time animations of vehicles moving through the intersection, pedestrians crossing the street, and traffic signals changing. Annotators in the simulator could make decisions such as steering, braking, or accelerating based on the evolving scenario. For instance, they may need to decide whether to yield to a police car or proceed cautiously through the intersection if the siren and lights are inactive.

Additionally, or alternatively, the simulator 500 may include auditory cues, such as engine sounds, honking horns, or the sound of a police siren, to further enhance realism. Annotators may evaluate how auditory information influences decision-making in the scenario. For example, hearing a siren might prompt an annotator to stop the ego vehicle at the side of the road, while the absence of such cues might lead to a different action.

The immersive setup of the simulator 500 enables annotators to experience scenarios from a first-person perspective, providing a unique layer of context that is not achievable in a static bird's-eye view. The simulator 500 allows for the collection of behavioral data, such as how an annotator manipulates the steering wheel or pedals in response to a given scenario. This data can enrich the training dataset by incorporating motor responses and decision-making processes into the annotations.

As discussed above, the training data system, such as the training data system 300 described with reference to FIG. 3, facilitates a structured dialog between annotators. For example, an annotator interaction module and/or a moderation module may assist in providing instructions for each step, such as adding an answer, posing a follow-up question, or introducing a new task. By scheduling different annotators and models to interact and challenge each other, the training data system fosters comprehensive discussions that yield both visual and textual annotations. These annotations go beyond superficial observations to uncover deeper insights into the scenarios being analyzed.

As discussed, the training data system may use a multimodal approach to gather training data. For example, the training data system may collect a combination of data types, including graphic annotations, steering inputs, and/or textual information. By gathering multimodal training data, a model training system may train models that integrate these modalities to perform a range of tasks. These tasks include planning and control for autonomous systems, as well as language understanding and generating language-based explanations of their actions. By combining these inputs, the training data system generates training data that may be used to train models to handle complex, real-world scenarios that require a holistic understanding of both physical interactions and contextual reasoning.

As discussed, in some examples, a training data system incentivizes annotators to provide high-quality, detailed answers by employing a combination of strategies. For example, one or both of an annotator interaction module 304 or a moderation module 304, as described with reference to FIG. 3, may dynamically pose questions and provide feedback to the annotators to encourage the annotators to refine their inputs. Incentives may include monetary rewards, gamified scoring systems, or recognition mechanisms, such as offering feedback that suggests their contributions are highly valued. For example, the training data system may simulate feedback, such as stating, “This response was highly appreciated by a reviewer,” even if the reviewer is a simulated entity or non-existent. This approach motivates annotators to engage more deeply with the task and produce better outputs.

Collecting training data through structured annotations via a training data system, such as the training data system 300 described with reference to FIG. 3, offers several advantages over relying solely on real-world data collection. First, the training data system allows for the exploration of scenarios that would be unsafe or impractical to recreate in the real world. Annotators can imagine or simulate situations that would be difficult to test physically, such as navigating an intersection where multiple vehicles simultaneously violate traffic rules. While some scenarios can be simulated with driving tools, this training data system goes beyond capturing different aspects of decision-making, not just how someone drives. For example, annotators can answer questions such as, “Where is the stopping line?” or “How far into the intersection is it still acceptable to stop?” Annotators can also evaluate scenarios with varying perspectives, such as, “Where would you stop as a cautious driver versus an aggressive driver?”

These varied perspectives allow the training data system to collect complementary data. Real-world data might show that no driver stops more than five meters into an intersection, providing statistical insights. However, asking annotators to explicitly define where it is polite, bold, or dangerous to stop provides a broader scope of understanding that goes beyond raw behavior. This diversity may create a richer dataset that captures the nuances of human reasoning and decision-making. From a single scenario, the training data system collects data on multiple facets, enabling better training for models than a simple compilation of driving rollouts or histograms of driver behaviors.

The ability to encourage diverse questions and responses ensures the dataset reflects a wide range of viewpoints and situations. Annotators are guided to ask varied questions in multimodal ways, combining text, visual annotations, and simulated behavior. The training data system also integrates feedback from model performance, identifying areas where the model is stronger or weaker, and tailoring the conversations to address gaps. By incorporating these targeted discussions into the annotation process, the system generates a highly diverse and comprehensive dataset, providing machine learning models with the robust training data necessary for improved reasoning, planning, and decision-making.

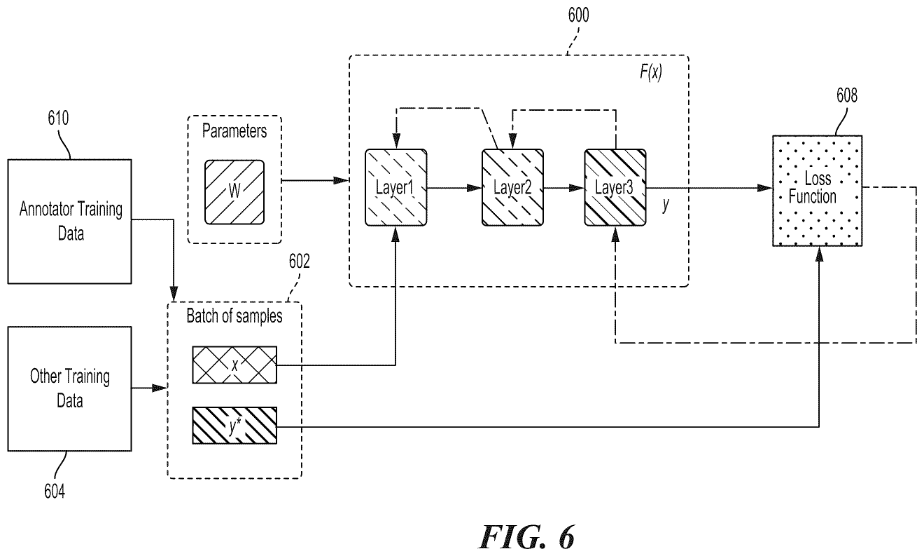

As discussed, various aspects of the present disclosure may be used to generate training data. In some examples, the training data may be used to train a model, such as a model used for autonomous driving or semi-autonomous driving. FIG. 6 is a block diagram illustrating an example for training a model 600, in accordance with various aspects of the present disclosure. In one configuration, training data 604, 610 may be stored at a data source, such as a server. As shown in FIG. 6, the training data 604, 610 may include annotator training data 610 and other training data 604. The annotator training data 610 may be obtained from a training data system, such as the training data system 300 described with reference to FIG. 3. More specifically, the annotator training data 610 may be obtained from the standardizing module 350 of the training data system 300 described with reference to FIG. 3. The other training data 604 may be obtained from other sources, such as, but not limited to, real-world data obtained from one or more vehicles. In some examples, only the annotator training data 610 is used to train the model 600.

The different training data 604, 610 may be stored on separate servers, distinguished via metadata, or some other type of distinction. During training, a set of samples 602 are selected from one or more sources of training data 604, 610. The set of samples 602 includes the input data x, such as the simulated data and the real world data. Additionally, the set of samples 602 may include ground truth labels y* corresponding to the input data x.

The model 600 may be initialized with a set of parameters w. The parameters may be used by layers of the model 600, such as layer 1, layer 2, and layer 3, of the model 600 to set weights and biases. During training, the model 600 receives input data x to transform the input data x to an output y. The output y may be instructions or commands for operating a vehicle in an autonomous or semi-autonomous manner. Other types of outputs are contemplated for the output y.

The output y of the model 600 is received at a loss function 608. The loss function 608 compares the output y to the ground truth label y*. The error is the difference (e.g., loss) between the transformed output y or non-transformed output y and the ground truth label y*. The error is output from the loss function 608 to the model 600. The error is backpropagated through the model 600 to update the parameters. The training may be performed during an offline phase of the model.

As discussed above, various aspects of the present disclosure are directed to generating training data to improve machine learning models, particularly for autonomous driving applications, through the use of an interactive data gathering session, such as a driving scenario generated by a training module. In some examples, a training data model generates the virtual scenario (e.g., interactive data gathering session) based on historical data (e.g., historical driving data). The training data model may incorporate contextual environmental details. This scenario is displayed to a group of annotators through interfaces such as top-down views or simulated driving environments. Annotators provide multimodal feedback, which may include visual annotations, textual responses, verbal comments, and/or physical inputs. For example, the physical inputs may include steering, acceleration, and/or braking inputs via a driving simulation device. The system collects this feedback in response to prompts initiated by other annotators and evaluates the multimodal feedback through a scoring process to ensure quality before integrating the multimodal feedback into a training dataset.

The system may generate follow-up questions based on the received multimodal feedback, prompting annotators to provide further insights, and ensuring iterative refinement of the dataset. A large language model (LLM) facilitates these interactions, acting as a virtual moderator to guide annotators, encourage diverse perspectives, and structure their responses. In some examples, multimodal feedback may be captured and converted into a standardized format to ensure consistency within the training dataset. High-quality feedback, as determined by evaluation scores exceeding a defined threshold, is incorporated into the dataset, improving the depth and reliability of the training data.

The multimodal inputs collected through the system enable the training of machine learning models to recognize and respond to complex driving scenarios. The resulting models are capable of planning and executing autonomous operations, including steering, acceleration, and braking, based on enriched datasets. This iterative process ensures robust model training, allowing for the autonomous operation of vehicles in real-world environments.

FIG. 7 is a flow diagram illustrating an example process 700 for gathering training data, in accordance with various aspects of the present disclosure. The process 700 may be performed by a training data system 300 described with reference to FIG. 3. As shown in FIG. 7, the process 700 begins at block 702 by generating a driving scenario based on one or more historical driving scenarios. The generated scenario may include contextual environmental details, such as road conditions, traffic patterns, pedestrian activity, and other elements relevant to vehicle operation. In some examples, the driving scenario may be a synthetic driving scenario, a semi-synthetic driving scenario, or a real-world driving scenario. Additionally, or alternatively, the driving scenario may be generated using a combination of real-world sensor data, manually created virtual environments, or augmented versions of existing scenarios. In some examples, generating a real-world driving scenario refers to providing a real-world driving scenario based on data captured by one or more sensors of a physical vehicle.

At block 704, the process 700 displays the driving scenario to a group of annotators via one or more interfaces. These interfaces may include a top-down view of a virtual environment generated via a display unit or a simulated view of the virtual environment via a display interface of a driving simulation device. In some implementations, the interface may allow annotators to manipulate the viewpoint, zoom in on specific areas of interest, or interact with the scenario in a structured manner.

At block 706, the process 700 provides, to the group of annotators, a feedback interface to solicit multimodal feedback from one or more annotators of the group of annotators. This feedback interface may support multiple input modalities, allowing annotators to provide visual annotations, textual responses, verbal feedback, or physical inputs via a driving simulation device. The multimodal nature of the feedback enables more comprehensive data collection, ensuring that the dataset reflects the complexities of real-world driving decisions.

At block 708, the process 700 receives, from a second annotator of the group of annotators in response to one or more prompts by at least a first annotator of the group of annotators, first multimodal feedback. The first multimodal feedback may include at least two of a visual annotation to the driving scenario, a textual response, a verbal response, or physical feedback via a driving simulation device. For example, the second annotator may draw a trajectory overlay on the scenario, provide a textual justification for a driving maneuver, or use a driving simulator to simulate a vehicle's movement in response to the scenario.

At block 710, the process 700 receives, from a third annotator, a first evaluation score of the first multimodal feedback. The third annotator assesses the quality, completeness, and accuracy of the multimodal feedback, assigning an evaluation score based on predefined criteria. The evaluation process ensures that only high-quality data is used for model training.

At block 712, the process 700 integrates the first multimodal feedback into a training dataset for training the machine learning model in accordance with the first evaluation score being greater than a score threshold. If the feedback meets or exceeds the score threshold, it is incorporated into the dataset. In some implementations, the multimodal feedback is captured in accordance with interactions of the second annotator with the one or more interfaces and converted into a standardized format associated with the training dataset. This standardization process ensures consistency across different data types, making the dataset more effective for training machine learning models.

In some examples, the process 700 trains the machine learning model in accordance with integrating the first multimodal feedback into the training dataset. Once trained, the machine learning model may be used to autonomously operate a vehicle based on the insights derived from the training data. This trained model can predict optimal driving behaviors, navigate complex scenarios, and make real-time decisions in autonomous or semi-autonomous vehicles.

In some examples, the process 700 may generate, via the training data model, one or more follow-up questions based on receiving the multimodal feedback. These follow-up questions may prompt annotators to refine their responses, explore alternative decision-making strategies, or validate certain aspects of the scenario. The system then receives, from the second annotator in response to the one or more follow-up questions, second multimodal feedback, allowing for iterative improvements in the dataset. Additionally, or alternatively, the process 700 receive, from the third annotator, a second evaluation score of the second multimodal feedback, ensuring the additional feedback meets the quality criteria before being added to the dataset. If the second evaluation score meets the threshold, the method may include integrating the second multimodal feedback into the dataset for training the machine learning model. In some examples, the training data model includes a large language model (LLM) trained to facilitate interactions between the group of annotators. The LLM may generate prompts, assess annotator responses, suggest follow-up questions, and guide the annotation process to maximize data quality and diversity.

In some examples, if the driving scenario involves an interactive simulation, the second annotator may provide steering, acceleration, and/or braking inputs for behavioral annotation via the driving simulation device. These physical interactions further enrich the dataset, enabling the model to learn from real-world driving behaviors.

As used herein, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for generating training data for machine learning models, the method comprising:
generating a driving scenario based on one or more historical driving scenarios, the driving scenario including contextual environmental details;
displaying the driving scenario to a group of annotators via one or more interfaces;
providing, to the group of annotators, a feedback interface to solicit multimodal feedback from one or more annotators of the group of annotators;
receiving, from a second annotator of the group of annotators in response to one or more prompts by at least a first annotator of the group of annotators, first multimodal feedback, the first multimodal feedback including two or more of a visual annotation to the driving scenario, a textual response, a verbal response, or physical feedback via a driving simulation device;
receiving, from a third annotator, a first evaluation score of the first multimodal feedback; and
integrating the first multimodal feedback into a training dataset for training the machine learning model in accordance with the first evaluation score being greater than a score threshold.

2. The method of claim 1, further comprising:
generating, via a training data model, one or more follow-up questions based on receiving the multimodal feedback;
receiving, from the second annotator in response to the one or more follow-up questions, second multimodal feedback;
receiving, from the third annotator, a second evaluation score of the first multimodal feedback; and
integrating the first multimodal feedback into a dataset for training the machine learning model in accordance with the second evaluation score being greater than the score threshold.

3. The method of claim 2, wherein the training data model includes a large language model (LLM) trained to facilitate interactions between the group of annotators.

4. The method of claim 1, wherein the one or more interfaces include one or more of a top-down view of a virtual environment generated via a display unit or a simulated view of the virtual environment via a display interface of the driving simulation device.

5. The method of claim 4, wherein the second annotator provides steering, acceleration, and/or braking inputs for behavioral annotation via the driving simulation device.

6. The method of claim 1, further comprising:
capturing the multimodal feedback in accordance with interactions of the second annotator with the one or more interfaces; and
converting the multimodal feedback into a standardized format associated with the training dataset.

7. The method of claim 1, further comprising:
training the machine learning model in accordance with integrating the first multimodal feedback into the training dataset; and
autonomously operating a vehicle via the trained machine learning model.

8. The method of claim 1, wherein the driving scenario is a synthetic driving scenario, a semi-synthetic driving scenario, or a real-world driving scenario.

9. An apparatus for generating training data for machine learning models, comprising:
one or more processors; and
one or more memories coupled with the one or more processors and storing processor-executable code that, when executed by the one or more processors, causes the apparatus to:
generate, via a training data model, a driving scenario based on one or more historical driving scenarios, the driving scenario including contextual environmental details;
display the driving scenario to a group of annotators via one or more interfaces;
provide, to the group of annotators, a feedback interface to solicit multimodal feedback from one or more annotators of the group of annotators;
receive, from a second annotator of the group of annotators in response to one or more prompts by at least a first annotator of the group of annotators, first multimodal feedback, the first multimodal feedback including two or more of a visual annotation to the driving scenario, a textual response, a verbal response, or physical feedback via a driving simulation device;
receive, from a third annotator, a first evaluation score of the first multimodal feedback; and
integrate the first multimodal feedback into a training dataset for training the machine learning model in accordance with the first evaluation score being greater than a score threshold.

10. The apparatus of claim 9, wherein execution of the processor-executable code further causes the apparatus to:
generate, via a training data model, one or more follow-up questions based on receiving the multimodal feedback;
receive, from the second annotator in response to the one or more follow-up questions, second multimodal feedback;
receive, from the third annotator, a second evaluation score of the first multimodal feedback; and
integrate the first multimodal feedback into a dataset for training the machine learning model in accordance with the second evaluation score being greater than the score threshold.

11. The apparatus of claim 9, wherein the one or more interfaces include a top-down view of a virtual environment or a simulated view of the virtual environment via a driving simulation device.

12. The apparatus of claim 11, wherein the second annotator provides steering, acceleration, and/or braking inputs for behavioral annotation via the driving simulation device, the behavioral annotation being integrated into the training dataset.

13. The apparatus of claim 9, wherein execution of the processor-executable code further causes the apparatus to:
capture the multimodal feedback in accordance with interactions of the second annotator with the one or more interfaces; and
convert the multimodal feedback into a standardized format associated with the training dataset.

14. The apparatus of claim 9, wherein execution of the processor-executable code further causes the apparatus to:
train the machine learning model in accordance with integrating the first multimodal feedback into the training dataset; and
autonomously operate a vehicle via the trained machine learning model.

15. A non-transitory computer-readable medium having program code recorded thereon for generating training data for machine learning models, the program code executed by one or more processors and comprising:
program code to generate, via a training data model, a driving scenario based on one or more historical driving scenarios, the driving scenario including contextual environmental details;
program code to display the driving scenario to a group of annotators via one or more interfaces;
program code to provide, to the group of annotators, a feedback interface to solicit multimodal feedback from one or more annotators of the group of annotators;
program code to receive, from a second annotator of the group of annotators in response to one or more prompts by at least a first annotator of the group of annotators, first multimodal feedback, the first multimodal feedback including two or more of a visual annotation to the driving scenario, a textual response, a verbal response, or physical feedback via a driving simulation device;
program code to receive, from a third annotator, a first evaluation score of the first multimodal feedback; and
program code to integrate the first multimodal feedback into a training dataset for training the machine learning model in accordance with the first evaluation score being greater than a score threshold.

16. The non-transitory computer-readable medium of claim 15, wherein the program code further comprises:
program code to generate, via a training data model, one or more follow-up questions based on receiving the multimodal feedback;
program code to receive, from the second annotator in response to the one or more follow-up questions, second multimodal feedback;
program code to receive, from the third annotator, a second evaluation score of the first multimodal feedback; and
program code to integrate the first multimodal feedback into a dataset for training the machine learning model in accordance with the second evaluation score being greater than the score threshold.

17. The non-transitory computer-readable medium of claim 15, wherein the one or more interfaces include a top-down view of a virtual environment or a simulated view of the virtual environment via a driving simulation device.

18. The non-transitory computer-readable medium of claim 17, wherein the second annotator provides steering, acceleration, and/or braking inputs for behavioral annotation via the driving simulation device.

19. The non-transitory computer-readable medium of claim 15, wherein the program code further comprises:
program code to capture the multimodal feedback in accordance with interactions of the second annotator with the one or more interfaces; and
program code to convert the multimodal feedback into a standardized format associated with the training dataset.

20. The non-transitory computer-readable medium of claim 15, wherein the program code further comprises:
program code to train the machine learning model in accordance with integrating the first multimodal feedback into the training dataset; and
program code to autonomously operate a vehicle via the trained machine learning model.
